(19) United States
(12) Patent Application Publication
(10) Pub. No.: US 2017/0369637 A1
(43) Pub. Date: Dec. 28, 2017

(54) HYDROCARBONATED POLYMERS WITH TWO ALCOXYSILANE END GROUPS

(71) Applicants: Bostik SA, La Plaine Saint-Denis (FR); Universite De Rennes, Rennes Cedex (FR); Centre National De La Recherche Scientifique, Paris (FR)

(72) Inventors: Guillaume MICHAUD, Compiegne (FR); Frédéric SIMON, Pont L'eveque (FR); Stéphane FOUQUAY, Mont Saint Aignan (FR); Xiaolu MICHEL, Rennes (FR); Sophie GUILLAUME, Vitre (FR); Jean-François CARPENTIER, Acigne (FR)

(21) Appl. No.: 15/544,932

(22) PCT Filed: Jan. 7, 2016
(86) PCT No.: PCT/FR2016/050026

§ 371 Date: Jul. 20, 2017

(30) Foreign Application Priority Data
Jan. 22, 2015 (FR) 1550500

(51) Int. Cl. C08G 61/08; C09J 5/00; C09J 165/00; C08G 61/12

(52) U.S. Cl. CPC C08G 61/08; C08G 61/128; C09J 5/00; C09J 165/00; C08G 2261/1644; C08G 2261/135; C08G 2261/3322; C08G 2261/418; C08G 2261/76; C08G 2261/3324

(57) ABSTRACT

The invention relates to 1) a hydrocarbonated polymer comprising two alcoxysilane end groups of formula (1), and 2) a method for producing said polymer, an adhesive composition comprising said polymer and the use of said adhesive composition.

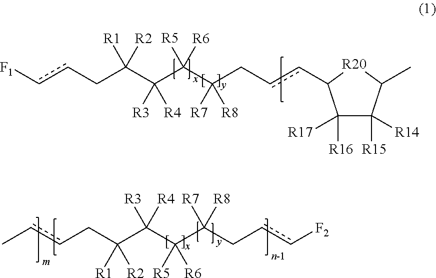

A subject matter of the present invention is hydrocarbon polymers comprising two alkoxysilane end groups, their preparation and their use.

Modified silane polymers (MS Polymers) are known in the field of adhesives. They are used for the assembling by adhesive bonding of a great variety of objects (or substrates). Thus, compositions based on MS polymers are applied, in combination with a catalyst, in the form of an adhesive layer, to at least one of two surfaces belonging to two substrates to be assembled and intended to be brought into contact with one another in order to assemble them. The MS polymer reacts by crosslinking with the water of the ambient environment and/or the water contributed by the substrates, which results in the formation of a cohesive adhesive seal ensuring the sturdiness of the assembly of these two substrates. This adhesive seal mainly consists of the MS polymer crosslinked to give a three-dimensional network formed by the polymer chains connected together by bonds of siloxane type. The crosslinking may take place before or after the two substrates are brought into contact and the application, if appropriate, of a pressure at their faying surface.

However, MS polymers generally have to be employed in the form of adhesive compositions comprising other constituents, such as, for example, tackifying resins, one or more additives having a reinforcing effect, such as, for example, at least one mineral filler, or else one or more additives targeted at improving the pot life (that is to say, the time at the end of which the crosslinking can be regarded as complete) or other characteristics, such as the rheology or the mechanical performance (elongation, modulus, and the like).

The patent application CA 2242060 describes the possibility of employing a composition of polymer-based adhesive seal type including at least one cycloolefin, a catalyst for ring-opening metathesis polymerization, a filler and a compound which comprises only a single silane functional group.

It is known to prepare telechelic polymers comprising an alkoxysilane end group and a vinyl end group, by means of a transfer agent containing just one silane functional group.

Thus, the patent application EP 2 468 783 describes the preparation of a polyurethane comprising polyurethane-polyether and polyurethane-polyester blocks with at least two polyurethane-polyester end blocks connected to an alkoxysilane end group, and also an adhesive composition comprising this polyurethane and a crosslinking catalyst. The silane end group results from an isocyanatosilane which comprises only a single silane functional group.

It is also known to prepare telechelic polymers comprising a repeat unit resulting from a cyclic monomer, such as, for example, norbornene.

Thus, the patent application WO 01/04173 describes the catalytic ring-opening metathesis copolymerization of branched cycloolefins comprising the same cycloolefin. Said cycloolefin is preferably norbornene.

In addition, the patent application WO 2011/038057 describes the ring-opening metathesis polymerization of norbornenedicarboxylic anhydrides and optionally of 7-oxanorbornenedicarboxylic anhydrides.

Finally, the patent application GB 2 238 791 describes a process for the polymerization of 7-oxanorbornene by ring-opening metathesis polymerization.

It is an aim of the present invention to provide novel polymers comprising two alkoxysilane end groups. These polymers can result, after crosslinking, in the formation of an adhesive seal exhibiting improved mechanical properties and in particular a higher cohesion, in comparison with those of the state of the art.

Thus, the present invention relates to a hydrocarbon polymer comprising two alkoxysilane end groups, said hydrocarbon polymer being of following formula (1):

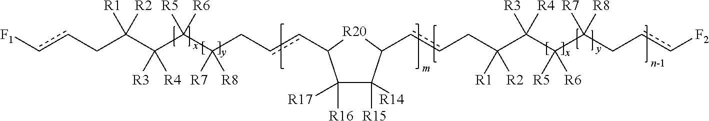

in which:

F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}; or else

F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}; or else

F₁ is (R′O)_{3-z}R_{z}Si—R″—NH—CO—(CH₂)ₚ₂— and F₂ is —(CH₂)_{q2}—CONH—R″—SiR_{z}(OR′)_{3-z};

where z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group, preferably a linear alkyl group, comprising from 1 to 4 and preferably from 1 to 2 carbon atoms; the R″ group is an alkylene group, preferably a linear alkylene group, comprising from 1 to 4 carbon atoms; and in which:
each carbon-carbon bond of the chain denoted [symbol] is a double bond or a single bond, in accordance with the valency rules of organic chemistry;
the R1, R2, R3, R4, R5, R6, R7 and R8 groups are independently a hydrogen, a halogen atom, an alkyl group, a heteroalkyl group, an alkoxycarbonyl group or a heteroalkoxycarbonyl group, it being possible for at least one of the R1 to R8 groups to form part of one and the same saturated or unsaturated ring or heterocycle with at least one other of the R1 to R8 groups, according to the valency rules of organic chemistry, and it being possible for at least one of the (R1,R2), (R3,R4), (R5,R6) and (R7,R8) pairs to be an oxo group;
x and y are integers independently within a range extending from 0 to 5, preferably from 0 to 2; more preferably still, x is equal to 1 and y is equal to 1, the sum x+y preferably being within a range from 0 to 4 and more preferably still from 0 to 2;
the R14, R15, R16 and R17 groups are independently a hydrogen, a halogen atom, an alkyl group, an alkenyl group, a heteroalkyl group, an alkoxycarbonyl group or a heteroalkoxycarbonyl group, it being possible for at least one of the R14 to R17 groups to form part of one and the same saturated or unsaturated ring or heterocycle with at least one other of the R14 to R17 groups, according to the valency rules of organic chemistry;
the R20 group is CH₂, O, S, NR₀ or C(═O), R₀ being an alkyl or alkenyl group, preferably a linear alkyl or alkenyl group, comprising from 1 to 22, preferably from 1 to 14, carbon atoms; and
n is an integer greater than or equal to 2 and m is an integer greater than or equal to 0, the molar ratio m:n being within a range from 0:1 to 0.5:1, preferably from 0:1 to 0.3:1; n and m in addition being such that the number-average molar mass Mn of the hydrocarbon polymer of formula (1) is within a range from 400 to 50 000 g/mol, preferably from 600 to 20 000 g/mol, and the polydispersity (PDI) of the hydrocarbon polymer of formula (1) is within a range from 1.0 to 3.0, preferably from 1.0 to 2.0, more preferably still from 1.45 to 1.85.

Very obviously, all the formulae are given here in accordance with the valency rules of organic chemistry.

The main chain of the polymer of formula (1) thus comprises one or two types of repeat units, a first type of repeat unit repeated n times and a second, optional, type of repeat unit repeated m times.

As is apparent above, the F₁ and F₂ end groups are generally symmetrical with respect to the main chain, that is to say that they substantially correspond, with the exception of the indices p1 and p2, and q1 and q2.

The term “alkyl group” is understood to mean a saturated linear or branched, cyclic, acyclic, heterocyclic or polycyclic hydrocarbon compound comprising, unless otherwise indicated, generally from 1 to 22 carbon atoms. Such an alkyl group generally comprises from 1 to 14, preferably from 1 to 8, carbon atoms. The term “heteroalkyl group” is understood to mean, according to the invention, an alkyl group in which at least one of the carbon atoms is replaced by a heteroatom chosen from the group formed by O and S.

The term “alkoxycarbonyl group” is understood to mean a saturated or partially unsaturated and linear or branched (monovalent) alkyl group comprising from 1 to 22, preferably from 1 to 14, carbon atoms, and also a divalent —COO— group. The term “heteroalkoxycarbonyl group” is understood to mean, according to the invention, an alkoxycarbonyl group in which at least one of the carbon atoms is replaced by a heteroatom chosen from the group formed by O and S.

The term “halogen atom” is understood to mean an iodo, chloro, bromo or fluoro group, preferably a chloro group.

The term “heterocycle” is understood to mean a hydrocarbon ring which can comprise another atom than carbon in the chain of the ring, such as, for example, oxygen, sulfur or nitrogen.

The term “alkoxysilane group” is understood to mean a group comprising a saturated or partially unsaturated and linear or branched alkyl group comprising from one to four, preferably from one to two, carbon atoms and, in addition, a divalent —Si—O— group.

The term “it being possible for at least one of the R1 to R8 groups to form part of one and the same saturated or unsaturated ring or heterocycle with at least one other of the R1 to R8 groups, according to the valency rules of organic chemistry” is understood to mean, according to the invention, that these two groups, whether or not they are carried by the same carbon, are bonded together by a hydrocarbon chain optionally comprising at least one heteroatom, such as S or O. Thus, for example, such a ring consists of R1-O—R8. This is also applicable to the R14 to R17 groups.

The term “it being possible for (R1,R2) pair to be an oxo group” means, according to the invention, that the (R1,R2) pair is such that

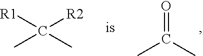

where C is the carbon which supports the two groups forming the (R1,R2) pair. This is also applicable to the (R3,R4), (R5,R6) and (R7,R8) pairs.

The term “end group” is understood to mean a group located at the chain end (or extremity) of the polymer. The polymer according to the invention comprises a main chain, i.e. a longer chain, the two extremities of which are the end groups of the polymer according to the invention.

The polydispersity PDI (or dispersity [symbol] _{M}) is defined as the ratio Mw/Mn, that is to say the ratio of the weight-average molar mass to the number-average molar mass of the polymer.

The two average molar masses Mn and Mw are measured according to the invention by Size Exclusion Chromatography (SEC), normally with PEG (PolyEthylene Glycol) or PS (PolyStyrene), preferably PS, calibration.

Particularly preferably, x is equal to 1 and y is equal to 1. Preferably, the R5 to R8 groups are each a hydrogen.

If z=0, then there is no R group in the formula (R′O)_{3-z}R_{z}Si—, which becomes (R′O)₃Si—.

If p2=0 or q2=0, then there is no (CH₂) group in the formula —(CH₂)ₚ₂—, which becomes —, or in the formula —(CH₂)_{q2}—, which becomes —.

When the index m, x or y which applies to a group of two square brackets is equal to zero, this means that there is no group between the square brackets to which this index applies. Thus,

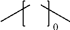

means [symbol] , and

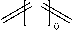

means [symbol] .

According to one embodiment of the invention, all the [symbol] bonds of the formula (1) are carbon-carbon double bonds, and the formula (1) then becomes the following formula (1′):

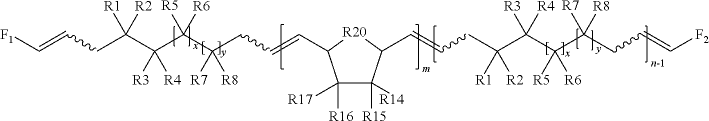

in which x, y, m, n, F₁, F₂, R1, R2, R3, R4, R5, R6, R7, R8, R14, R15, R16, R17 and R20 have the meanings given above and the [symbol] bond is a bond geometrically oriented on one side or the other with respect to the double bond (cis or trans).

According to another embodiment of the invention, all the [symbol] bonds of the formula (1) are carbon-carbon single bonds, and the formula (1) then becomes the formula (1H) which is described below.

Each of the double bonds of the polymer of formula (1′) is geometrically cis or trans oriented; preferably is of cis orientation. The geometric isomers of the polymer of formula (1′) are generally present in variable proportions, generally with a majority of cis (Z)-cis (Z)-cis (Z)-cis (Z). It is preferred according to the invention to have mixtures, the double bonds of which are predominantly cis (Z) oriented, and preferably are all cis (Z) oriented. It is also possible according to the invention to obtain just one of the geometric isomers, according to the reaction conditions and in particular according to the nature of the catalyst used.

According to one of the embodiments of the invention, m is equal to 0, the polymer being of following formula (2):

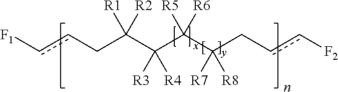

in which x, y, n, F₁, F₂, R1, R2, R3, R4, R5, R6, R7 and R8 have the meanings given above.

The formula (2) illustrates the case where the main chain of the polymer of formula (1) comprises just one type of repeat unit, repeated n times.

Particularly preferably, x is equal to 1 and y is equal to 1.

The invention also relates to a polymer of following formula (1H):

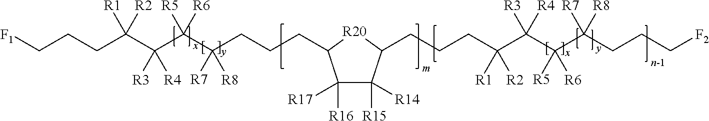

in which x, y, n, m, F₁, F₂, R1, R2, R3, R4, R5, R6, R7, R8, R14, R15, R16, R17 and R20 have the meanings given above.

The formula (1H) illustrates the case where the main chain of the polymer of formula (1) is saturated, that is to say comprises only saturated bonds.

In this case, preferably, x is equal to 1 and y is equal to 1.

The polymer of formula (1H) can, for example, result from the hydrogenation of the unsaturated polymer of formula (1′).

In one of the embodiments, m is equal to 0, the polymer being of following formula (2H):

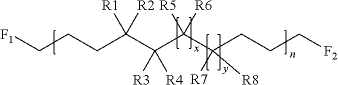

in which x, y, n, F₁, F₂, R1, R2, R3, R4, R5, R6, R7 and R8 have the meanings given above.

The formula (2H) illustrates the case where the main chain of the polymer of formula (1H) comprises just one type of repeat unit, repeated n times.

In this case, preferably, x is equal to 1 and y is equal to 1.

According to a first embodiment (known as “γ-dicarbamate route”), F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}, with p1=1 or q1=1, preferably p1=q1=1. In this case, preferably, R′ is a methyl, R″ is the —(CH₂)₃— group, z=0, p1=1 and q1=1.

According to a second embodiment (known as “α-dicarbamate route”), F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}, with p1=1 or q1=1, preferably p1=q1=1. In this case, preferably, R and R′ are each a methyl, R″ is the —CH₂— group, z=1, p1=1 and q1=1.

According to a third embodiment (known as “γ-diurea route”), F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}, with p1=1 or q1=1, preferably p1=q1=1. In this case, preferably, R′ is a methyl, R″ is the —(CH₂)₃— group, z=0, p1=1 and q1=1.

According to a fourth embodiment (known as “α-diurea route”), F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}, with p1=1 or q1=1, preferably p1=q1=1. In this case, preferably, R and R′ are each a methyl, R″ is the —CH₂— group, z=1, p1=1 and q1=1.

According to a fifth embodiment (known as “γ-diamide route”), F₁ is (R′O)_{3-z}R_{z}Si—R″—NH—CO—(CH₂)ₚ₂— and F₂ is —(CH₂)_{q2}—CO—NH—R″—SiR_{z}(OR′)_{3-z}, with p2=0 or q2=0, preferably p2=q2=0. In this case, preferably, R′ is a methyl, R″ is the —(CH₂)₃— group, z=0, p2=0 and q2=0.

According to a sixth embodiment (known as “α-diamide route”), F₁ is (R′O)_{3-z}R_{z}Si—R″—NH—CO—(CH₂)ₚ₂— and F₂ is —(CH₂)_{q2}—CO—NH—R″—SiR_{z}(OR′)_{3-z}, with p2=0 or q2=0, preferably p2=q2=0. In this case, preferably, R′ is a methyl, R″ is the —CH₂— group, z=0, p2=0 and q2=0.

The polymers of formulae (1), (1′), (1H), (2) and (2H) according to the invention are particularly homogeneous and temperature stable. They are preferably packaged and stored with the exclusion of moisture.

The polymers of formulae (1), (1′), (1H), (2) and (2H) according to the invention can form, after crosslinking with the water of the ambient environment and/or the water contributed by at least one substrate, generally atmospheric moisture, for example for a relative humidity of the air (also known as degree of hygrometry) usually within a range from 25 to 65%, and in the presence of an appropriate crosslinking catalyst, an adhesive seal which exhibits high cohesive values. Such cohesive values make possible use as adhesive, for example as leaktightness seal on an ordinary support (concrete, glass, marble), in the construction industry, or also for the adhesive bonding of glazings in the motor vehicle and shipbuilding industries.

This ability which the polymers according to the invention have to crosslink in the presence of moisture is thus particularly advantageous.

Furthermore, the noncrosslinked polymers according to the invention are solid or liquid polymers at ambient temperature (i.e. approximately 20° C.). Preferably, they are liquid polymers having a viscosity at 23° C. ranging from 1 to 500 000 mPa·s, preferably from 1 to 150 000 mPa·s and more preferably still from 1 to 50 000 mPa·s. When m is different from 0 and/or one at least of the R1 to R8 and/or R14 to R17 groups comprises an alkyl group, the noncrosslinked polymers according to the invention are preferably liquid polymers having a viscosity at 23° C. ranging from 1 to 500 000 mPa·s.

When the noncrosslinked polymer according to the invention is solid at ambient temperature, it is generally thermoplastic (in an anhydrous medium), that is to say deformable and meltable under hot conditions (i.e. at a temperature greater than ambient temperature). It can thus be used as hot-melt adhesive and applied under hot conditions to the interface of substrates to be assembled at their faying surface. By solidifying at ambient temperature, an adhesive seal rendering the substrates integral is thus immediately created, then giving the adhesive advantageous properties of reduced pot life.

When the noncrosslinked polymer according to the invention is a more or less viscous liquid at ambient temperature, the adhesive composition which comprises it can comprise at least one additional constituent, such as a tackifying resin or a filler.

The invention also relates to a process for the preparation of at least one hydrocarbon polymer comprising two alkoxysilane end groups according to the invention, said process comprising at least one stage of ring-opening metathesis polymerization, in the presence:
of at least one metathesis catalyst, preferably a ruthenium-comprising catalyst, more preferably still a Grubbs catalyst,
of at least one difunctional alkoxysilane chain transfer agent (CTA) of following formula (C):

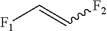

in which the [symbol] bond is a bond geometrically oriented on one side or the other, with respect to the double bond (cis or trans); F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}; or else F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}; or else F₁ is (R′O)_{3-z}R_{z}Si—R″—NH—CO—(CH₂)ₚ₂— and F₂ is —(CH₂)_{q2}—CO—NH—R″—SiR_{z}(OR′)_{3-z}; where z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group, preferably a linear alkyl group, comprising from 1 to 4, preferably from 1 to 2, carbon atoms; the R″ group is an alkylene group, preferably a linear alkylene group, comprising from 1 to 4 carbon atoms;
of at least one compound of following formula (A):

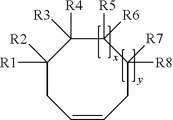

in which:
the R1, R2, R3, R4, R5, R6, R7 and R8 groups are independently a hydrogen, a halogen atom, an alkyl group, a heteroalkyl group, an alkoxycarbonyl group or a heteroalkoxycarbonyl group, it being possible for at least one of the R1 to R8 groups to form part of one and the same saturated or unsaturated ring or heterocycle with at least one other of the R1 to R8 groups, according to the valency rules of organic chemistry, and it being possible for at least one of the (R1,R2), (R3,R4), (R5,R6) and (R7,R8) pairs to be an oxo group;
x and y are integers independently within a range extending from 0 to 5, preferably from 0 to 2; more preferably still, x is equal to 1 and y is equal to 1, the sum x+y preferably being within a range from 0 to 4 and more preferably still from 0 to 2;
   and
      of optionally at least one compound of formula (B):

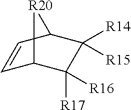

in which:
the R14, R15, R16 and R17 groups are independently a hydrogen, a halogen atom, an alkyl group, an alkenyl group, a heteroalkyl group, an alkoxycarbonyl group or a heteroalkoxycarbonyl group, it being possible for at least one of the R14 to R17 groups to form part of one and the same saturated or unsaturated ring or heterocycle with at least one other of the R14 to R17 groups, according to the valency rules of organic chemistry; and
the R20 group is CH₂, O, S, NR₀ or C(═O), R₀ being an alkyl group, preferably a linear alkyl group, comprising from 1 to 22, preferably from 1 to 14, carbon atoms;
   for a reaction time ranging from 2 to 24 hours and at a temperature within a range from 20 to 60° C.

The time and the temperature for a given reaction generally depend on the reaction conditions and in particular on the content of catalytic filler. A person skilled in the art is in a position to adjust them as a function of the circumstances.

The CTA is a compound which comprises two silane functional groups.

The molar ratio of the CTA to the compound of formula (A), or to the sum of the compounds of formulae (A) and (B) if the compound of formula (B) is present, is within a range from 0.01 to 0.10, preferably from 0.05 to 0.10.

The compounds of formula (A) generally comprise from 6 to 30, preferably from 6 to 22, carbon atoms.

The compounds of formula (B) generally comprise from 6 to 30, preferably from 6 to 22, carbon atoms.

In a preferred embodiment of the invention, x=y=1.

The ring-opening metathesis polymerization is a reaction well known to a person skilled in the art, which is carried out here in the presence of a specific CTA compound of formula (C).

The cyclic compounds of formula (A) are preferably, according to the invention, chosen from the group formed by cycloheptene, cyclooctene, cyclononene, cyclodecene, cycloundecene, cyclododecene, 1,5-cyclooctadiene, cyclononadiene and 1,5,9-cyclodecatriene.

Cyclooctene (COE)

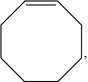

5-epoxycyclooctene

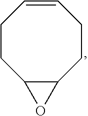

5-oxocyclooctene

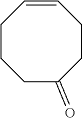

and 5-alkylcyclooctenes

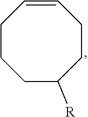

where R is an alkyl group comprising from 1 to 22, preferably from 1 to 14, carbon atoms, are preferred according to the invention, cyclooctene being very particularly preferred. For example, R is a n-hexyl group.

The cyclic compounds of formula (B) are preferably, according to the invention, chosen from the group formed by norbornene, norbornadiene, dicyclopentadiene, 7-oxanorbornene and 7-oxanorbornadiene, which are respectively of following formulae:

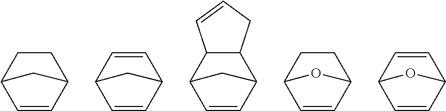

Norbornene and 7-oxanorbornene are particularly preferred.
The cyclic compounds of formula (B) can also be chosen from the group formed by the compounds of formulae:

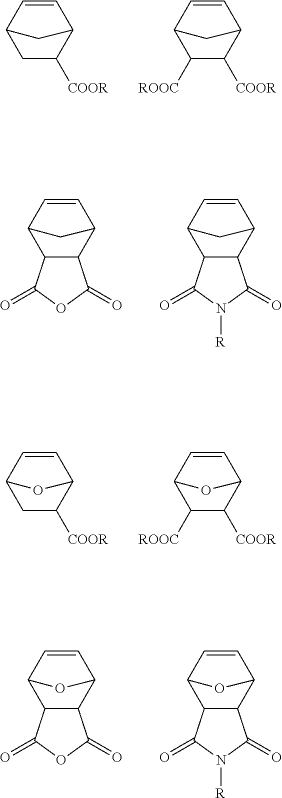

where R is an alkyl group comprising from 1 to 22, preferably from 1 to 14, carbon atoms. For example, R is a n-hexyl group.

The cyclic compounds of formula (B) can also be chosen from the group formed by the addition products (or adducts) resulting from the Diels-Alder reaction using cyclopentadiene or furan as starting material, and also the compounds derived from norbornene, such as branched norbornenes, such as described in WO 2001/04173 (such as: norbornene isobornyl carboxylate, norbornene phenyl carboxylate, norbornene ethylhexyl carboxylate, norbornene phenoxyethyl carboxylate and alkyl norbornene dicarboxyimide, the alkyl generally comprising from 3 to 8 carbon atoms), and branched norbornenes, such as described in WO 2011/038057 (norbornene dicarboxylic anhydrides and optionally 7-oxanorbornene dicarboxylic anhydrides).

According to a first and second embodiment (known as “dicarbamate route”), the CTA is of following formula (C1):

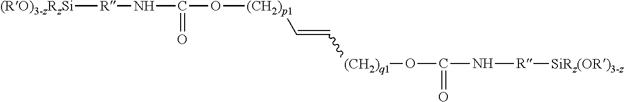

in which z, R, R′, p1, q1 and [symbol] have the meanings given above.

In this case, preferably:

R′ is a methyl and R″ is a propylene —(CH₂)₃— with z=0, p1=1 and q1=1, or else

R and R′ are each a methyl and R″ is a methylene —CH₂— with z=1, p1=1 and q1=1.

This compound is synthesized quantitatively by reaction of 2 moles of an α-isocyanatosilane (such as (isocyanatomethyl)methyldimethoxysilane) or 2 moles of a γ-isocyanatosilane (such as 3-isocyanatopropyltrimethoxysilane) which are sold under the Geniosil® brand by Wacker Chemie with 1 mole of unsaturated linear diol (for example 2-butene-1,4-diol, GAS: 110-64-5) available from Aldrich.

According to a third and fourth embodiment (known as “diurea route”), the CTA is of following formula (C2):

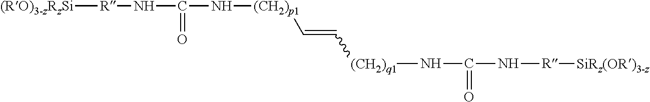

in which z, R, R′, p1, q1 and [symbol] have the meanings given above.

In this case, preferably:

R′ is a methyl and R″ is a propylene —(CH₂)₃— with z=0, p1=1 and q1=1, or else

R and R′ are each a methyl and R″ is a methylene —CH₂— with z=1, p1=1 and q1=1.

This compound is synthesized quantitatively by reaction of 2 moles of an α-isocyanatosilane (such as (isocyanatomethyl)methyldimethoxysilane) or 2 moles of a γ-isocyanatosilane (such as 3-isocyanatopropyltrimethoxysilane) which are sold by Wacker Chemie under the Geniosil® brand with 1 mole of unsaturated linear diamine (for example 1,4-diamino-2-butene, which can be synthesized by conversion of 1,4-dibromo-2-butene according to WO 92/21235 or according to Koziara et al., Synthesis, 1985, 202, or from 1,4-dibromo-2-butene according to L. H. Amundsen et al., J. Am. Chem. Soc., 1951, 73, 2118).

According to a fifth and sixth embodiment (known as “diamide route”), the CTA is of following formula (C3):

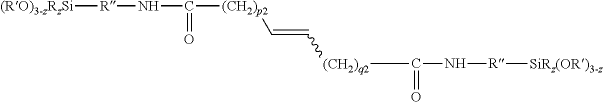

in which z, R, R′, R″, p2, q2 and [symbol] have the meanings given above.

In this case, preferably:

R′ is a methyl and R″ is a propylene —(CH₂)₃— with z=0, p2=0 and q2=0, or else

R and R′ are each a methyl and R″ is a methylene —CH₂— with z=1, p2=0 and q2=0.

This compound can be synthesized by amidation of unsaturated linear dicarboxylic acids or the corresponding anhydrides with 2 moles of an α-aminosilane (such as (aminomethyl)methyldimethoxysilane) or 2 moles of a γ-isocyanatosilane (such as 3-aminopropyltrimethoxysilane) which are sold by Wacker Chemie under the Geniosil® brand. The compound obtained from maleic anhydride, which is preferred according to the invention, necessitates passing through a stage of protection/deprotection of the double bond in order to avoid undesirable side reactions.

The stage of ring-opening metathesis polymerization (or ROMP) is generally carried out in the presence of at least one solvent, generally chosen from the group formed by the aqueous or organic solvents typically used in polymerization reactions and which are inert under the conditions of the polymerization, such as aromatic hydrocarbons, chlorinated hydrocarbons, ethers, aliphatic hydrocarbons, alcohols, water or their mixtures. A preferred solvent is chosen from the group formed by benzene, toluene, para-xylene, methylene chloride, dichloroethane, dichlorobenzene, chlorobenzene, tetrahydrofuran, diethyl ether, pentane, hexane, heptane, methanol, ethanol, water or their mixtures. More preferably still, the solvent is chosen from the group formed by benzene, toluene, para-xylene, methylene chloride, dichloroethane, dichlorobenzene, chlorobenzene, tetrahydrofuran, diethyl ether, pentane, hexane, heptane, methanol, ethanol or their mixtures. More particularly preferably still, the solvent is toluene, heptane or a mixture of toluene and methylene chloride. The solubility of the polymer formed during the polymerization reaction depends generally and mainly on the choice of the solvent and on the molar mass of the polymer obtained. It is also possible for the reaction to be carried out without solvent.

The metathesis catalyst, such as, for example, a Grubbs catalyst, is generally a commercial product.

The metathesis catalyst is generally a transition metal catalyst, including in particular a ruthenium-comprising catalyst, generally in the form of ruthenium complex(es), such as a ruthenium-carbene complex. Use may thus particularly preferably be made of Grubbs catalysts. The term “Grubbs catalyst” is generally understood to mean, according to the invention, a 1^{st} or 2^{nd} generation Grubbs catalyst but also any other catalyst of Grubbs type (of ruthenium-carbene type) accessible to a person skilled in the art, such as, for example, the substituted Grubbs catalysts described in the U.S. Pat. No. 5,849,851.

A 1^{st} generation Grubbs catalyst is generally of formula (8):

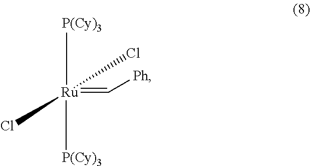

in which Ph is phenyl and Cy is cyclohexyl.

The P(Cy)₃ group is a tricyclohexylphosphine group.

The IUPAC name of this compound is: benzylidenebis(tricyclohexylphosphine)dichlororuthenium (of CAS number 172222-30-9).

A 2^{nd} generation (or G2) Grubbs catalyst is generally of formula (9):

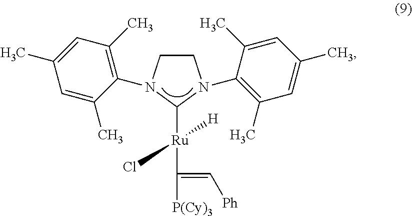

in which Ph is phenyl and Cy is cyclohexyl.

The IUPAC name of the second generation of this catalyst is benzylidene[1,3-bis(2,4,6-trimethylphenyl)-2-imidazolidinylidene]dichloro(tricyclohexylphosphine)ruthenium (of CAS number 246047-72-3).

The process for the preparation of a hydrocarbon polymer according to the invention can additionally comprise at least one additional stage of hydrogenation of double bonds.

This stage is generally carried out by catalytic hydrogenation, most often under hydrogen pressure and in the presence of a hydrogenation catalyst, such as a catalyst of palladium supported by carbon (Pd/C). It more particularly makes it possible to form a compound of formula (1H) or (2H) starting from an unsaturated compound of formula (1′) or (2).

The invention also relates to an adhesive composition comprising a polymer according to the invention and from 0.01 to 3% by weight, preferably from 0.1 to 1% by weight, of a crosslinking catalyst, with respect to the weight of the adhesive composition. The polymer according to the invention is a polymer of formula (1), (1′), (1H), (2) or (2H).

The crosslinking catalyst can be used in the composition according to the invention and can be any catalyst known to a person skilled in the art for the condensation of silanol. Mention may be made, as examples of such catalysts, of:
organic titanium derivatives, such as titanium(IV) diisopropoxide bis(acetylacetonate) (available commercially under the name TYZOR® AA-75 from Dupont);
organic aluminum derivatives, such as the aluminum chelate available commercially under the name K-KAT® 5218 from King Industries;
organic tin derivatives, such as dibutyltin dilaurate (DBTL); and
amines, such as 1,8-diazabicyclo[5.4.0]undec-7-ene (DBU) and 1,5-diazabicyclo[4.3.0]non-5-ene (DBN).

It is also possible to include, in the composition according to the invention, UV stabilizers, such as amines, or antioxidants.

The antioxidants can comprise primary antioxidants, which trap free radicals and which are generally substituted phenols, such as Irganox®1010 from Ciba. The primary antioxidants can be used alone or in combination with other antioxidants, such as phosphites, for example Irgafos® 168 from Ciba.

According to a particularly preferred embodiment, the adhesive composition according to the invention is packaged in an airtight packaging prior to its final use, so as to protect it from ambient moisture. Such a packaging can advantageously be formed of a multilayer sheet which typically comprises at least one aluminum layer and/or at least one high-density polyethylene layer. For example, the packaging is formed of a layer of polyethylene coated with a sheet of aluminum. Such a packaging can in particular take the form of a cylindrical cartridge.

Finally, the invention relates to a process for adhesive bonding by assembling two substrates, comprising:
the coating of an adhesive composition as defined above, in the liquid form, preferably in the form of a layer with a thickness within a range from 0.3 to 5 mm, preferably from 1 to 3 mm, on at least one of the two surfaces which respectively belong to the two substrates to be assembled and which are intended to be brought into contact with one another along a faying surface; then
actually bringing the two substrates into contact along their faying surface.

The adhesive composition in the liquid form is either the (naturally) liquid adhesive composition or the molten adhesive composition. A person skilled in the art is in a position to proceed so that the adhesive composition used is in the liquid form at the time of its use.

Of course, the coating operation and the contacting operation have to be carried out within a compatible time interval, as is well known to a person skilled in the art, that is to say before the adhesive layer applied to the substrate loses its ability to attach, by adhesive bonding, this substrate to another substrate. In general, the crosslinking of the polymer of the adhesive composition, in the presence of the catalyst and of the water of the ambient environment and/or of the water contributed by at least one of the substrates, begins to take place during the coating operation and then continues to take place during the stage in which the two substrates are brought into contact. In practice, the water generally results from the relative humidity of the air.

The appropriate substrates are, for example, inorganic substrates, such as glass, ceramics, concrete, metals or alloys (such as aluminum alloys, steel, non-ferrous metals and galvanized metals); or else organic substrates, such as wood, plastics, such as PVC, polycarbonate, PMMA, polyethylene, polypropylene, polyesters or epoxy resins; substrates made of metal and composites coated with paint (as in the motor vehicle field).

A better understanding of the invention will be obtained in the light of the examples which follow, which illustrate the invention without, however, limiting the scope thereof.

### EXAMPLES

The synthesis reactions of the examples were carried out in two or three stages, with a stage of synthesis of the cycloolefin, a stage of synthesis of the transfer agent (CTA) of formula (C) and a stage of ring-opening metathesis polymerization of cycloolefin of formula (A) and optionally of compound of formula (B) in the presence of a Grubbs catalyst and of the transfer agent.

The general scheme 1 of the polymerization reactions carried out in examples 1 to 8 is given below and will be clarified on an individual basis in the detailed examples.

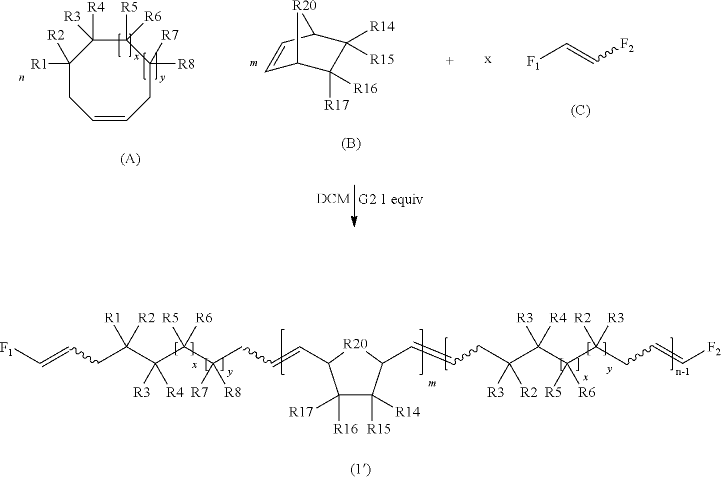

In this scheme 1:

DCM means dichloromethane

the [symbol] bond is a bond geometrically oriented on one side or the other, with respect to the double bond (cis or trans); CTA is the chain transfer agent of formula (C); the cycloolefins are of formulae (A) and (B),

G2 is the metathesis catalyst of formula (9):

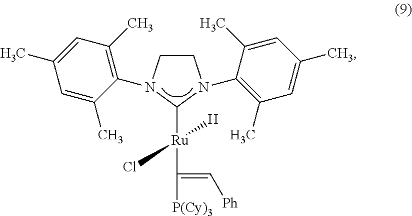

in which Ph is phenyl and Cy is cyclohexyl;

the F₁ and F₂ groups are symmetrical and correspond respectively to the —CH₂—OOC—NH—(CH₂)₃—Si(OCH₃)₃ group (case where the CTA is a γ-dicarbamate), to the —CH₂—NH—CO—NH—(CH₂)₃—Si(OCH₃)₃ group (case where the CTA is a γ-diurea) and to the —CO—NH—(CH₂)₃—Si(OCH₃)₃ group (case where the CTA is a γ-diamide);

n is the number of moles of cycloolefins of formula (A);

m is the number of moles of cycloolefins of formula (B);

x is the number of moles of CTA of formula (C).

The number of monomer units in the polymer is equal to n+m.

In each of examples 1 to 8 described below using scheme 1, the reaction lasts 24 h at a temperature of 40° C.

All the polymerizations were carried out similarly. The only differences lie in the nature and the initial concentration of the chain transfer agent(s) (CTA). The γ-dicarbamate (CTA¹), the γ-diurea (CTA²) and the γ-diamide (CTA³), illustrating the invention, which are used in examples 1 to 8, have the following respective formulae:

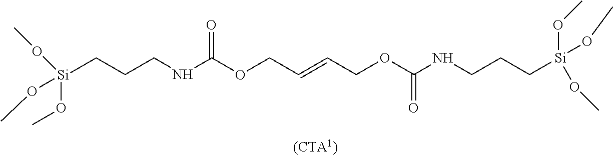

(which corresponds to the case where F₁ is (R′O)_{3-z}R_{z}Si—R″—NH—COO—(CH₂)ₚ₁— and F₂ is —(CH₂)_{q1}—OOC—NH—R″—SiR_{z}(OR′)₃, with R′=methyl, R″═—(CH₂)₃—, z=0, p1=1 and q1=1);

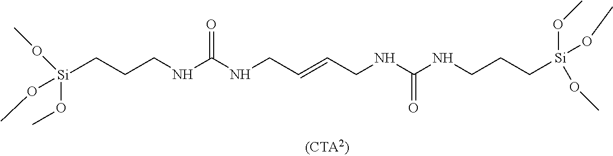

(which corresponds to the case where F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)₃, with R′=methyl, R″═—(CH₂)₃—, z=0, p1=1 and q1=1);

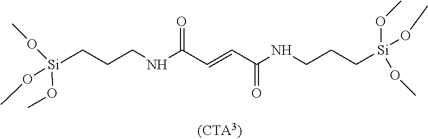

(which corresponds to the case where F₁ is (R′O)_{3-z}R_{z}Si—R″—NH—CO—(CH₂)ₚ₂— and F₂ is —(CH₂)_{q2}—CO—NH—R″—SiR_{z}(OR′)₃, with R′=methyl, R″═—(CH₂)₃—, z=0, p2=0 and q2=0).

Two reaction possibilities exist, according to whether the cycloolefin of formula (A) is used alone (examples 1 to 6) or according to whether the cycloolefins of formulae (A) and (B) are used as a mixture (examples 7 and 8).

### Examples 1 to 6: Polymerization of the Cycloolefins of Formula (A)

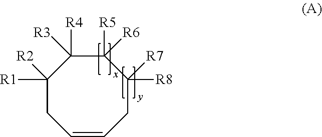

The polymerization process described below corresponds to examples 1 to 4 (the results of which are shown in table 1 below), to example 5 (cf table 2) and to example 6 (cf table 3).

The cycloolefins of formula (A) used in these examples are as follows:

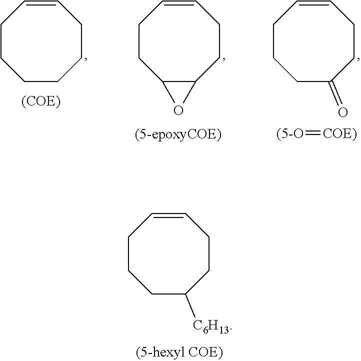

The cyclooctene (COE) and the 5,6-epoxycyclooctene (5-epoxyCOE) were commercial products from Sigma-Aldrich.

The 5-oxocyclooctene (5-O═COE) and the 5-n-hexyl-cyclooctene (5-hexyl-COE) were synthesized from 5,6-epoxycyclooctene (5-epoxy-COE) according to the route shown in the following reaction scheme 2:

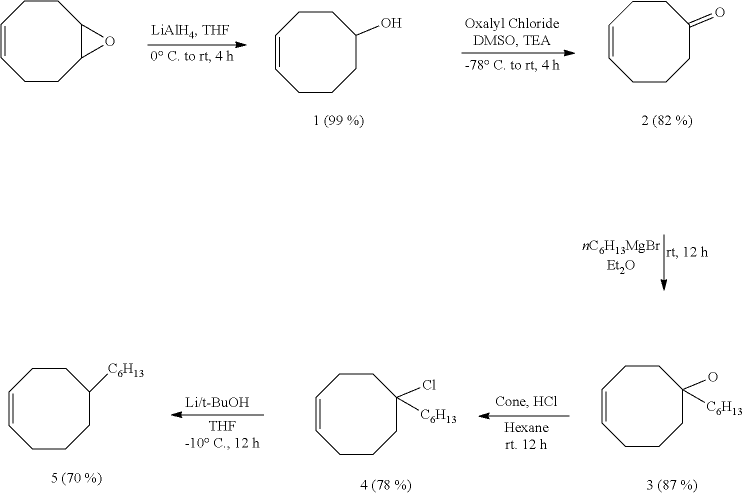

The 5-oxocyclooctene (5-O═COE, referenced 2 in the scheme above) was synthesized according to the procedure shown in the publication of A. Diallo et al., Polymer Chemistry, Vol. 5, Issue 7, 7 Apr. 2014, pp. 2583-2591 (which referred to Hillmyer et al., Macromolecules, 1995, 28, 6311-6316).

The 5-hexylcyclooctene (5-hexyl-COE, referenced 5 in the scheme above) was synthesized according to the procedure shown in the publication of A. Diallo et al., Polymer Chemistry, mentioned above (which referred to Kobayashi et al., J. Am. Chem. Soc., 2011, 133, pp. 5794-5797).

The starting materials, reactants and solvents used during these syntheses were commercial products from Sigma-Aldrich.

A cycloolefin of formula (A) described above (10.8 mmol) and dry CH₂Cl₂ (5 ml) were placed in a 100 ml round-bottomed flask in which was also placed a Teflon®-coated magnetic stirring bar. The round-bottomed flask and its contents were subsequently placed under argon. The compound of formula CTA¹ (0.54 mmol) was then introduced using a syringe into the round-bottomed flask. The round-bottomed flask was then immersed in an oil bath at 40° C. and then the catalyst G2 (5.4 μmol) in solution in CH₂Cl₂ (2 ml) was immediately added using a hollow needle. The reaction mixture then became very viscous in the space of two minutes. The viscosity subsequently slowly decreased over the following 10 minutes. After 24 h, counting from the addition of the catalyst, the product present in the round-bottomed flask was extracted after the solvent was concentrated under vacuum. A product was then recovered after precipitating from methanol, filtering and drying at 20° C. under vacuum (Yield of greater than 90% for each of examples 1 to 6). The ¹H/¹³C NMR analysis made it possible to demonstrate that the product was indeed a polymer having the expected formula.

All the polymers prepared in the examples were recovered as a solid powder or as a liquid, depending on the nature of the cycloolefin, which is colorless, easily soluble in chloroform and insoluble in methanol.

The different tests of examples 1 to 6 are summarized in tables 1, 2 and 3 described in detail below.

TABLE 1

| | | Conversion | Mn_{SEC} | |
|---|---|---|---|---|
| Test No. | [A]/[CTA¹]/[Ru] (mol/mol) | A (%) | (g/mol) | PDI |
| 1 | 2 000/100/1 | | 4 600 | 1.53 |
| 2 | 2 000/100/1 | 100 | 5 200 | 1.47 |
| 3 | 2 000/100/1 | 100 | 4 800 | 1.50 |
| 4 | 2 000/100/1 | 100 | 5 000 | 1.51 |

where CTA¹ = γ-dicarbamate

TABLE 2

| | | Conversion | Mn_{SEC} | |
|---|---|---|---|---|
| Test No. | [A]/[CTA²]/[Ru] (mol/mol) | A (%) | (g/mol) | PDI |
| 5 | 2 000/100/1 | 100 | 4 900 | 1.49 |

where CTA² = γ-diurea

TABLE 3

| | | Conversion | Mn_{SEC} | |
|---|---|---|---|---|
| Test No. | [A]/[CTA³]/[Ru] (mol/mol) | A (%) | (g/mol) | PDI |
| 6 | 2 000/100/1 | 100 | 5 300 | 1.52 |

where CTA³ = γ-diamide

### Example 1: Synthesis of a Polymer Comprising Two Alkoxysilane End Groups Starting from Cyclooctene (COE) and CTA¹

The reaction was carried out according to the following scheme 3:

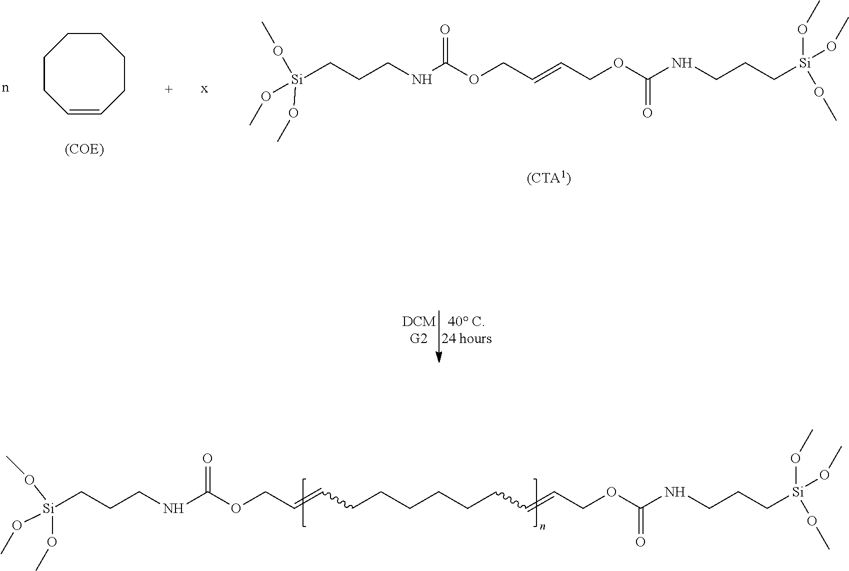

The polymer obtained was solid at ambient temperature.

The NMR analyses of the polymer obtained for this test gave the following values, which have confirmed the structure of the polymer:

¹H NMR (CDCl₃, 500 MHz, 298 K): δ (ppm) repeat unit 1.29 (8H*n), 1.96 (4H*n), 5.37 (2H*n), end group=0.64 (4H, m, —CH₂—CH₂—Si—), 1.61 (4H, m, —NH—CH₂—CH₂—CH₂—Si—), 3.16 (4H, m, —NH—CH₂—CH₂—CH₂—Si—), 3.57 (18H, s, —Si—O—CH₃), 4.48 (4H, t, —CO—O—CH₂—CH═), 5.73 (2H, m, —CH═CH—CH₂—O—CO—), 5.77 (2H, m, —CH═CH—CH₂—O—CO—).

¹³C NMR (CDCl₃, 100 MHz, 298 K): δ (ppm) repeat unit 29.17, 29.54, 29.78, 32.37, 33.10, 130.48, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 65.57 (—CO—O—CH₂—CH═), 124.41 (CH═CH—CH₂—O—CO—), 136.05 (—CH═CH—CH₂—O—CO—), 156.50 (—O—CO—).

### Example 2: Synthesis of a Polymer Comprising Two Alkoxysilane End Groups Starting from Cyclooctene Monoepoxide (5-EpoxyCOE) and CTA¹

The reaction was carried out according to the following scheme 4:

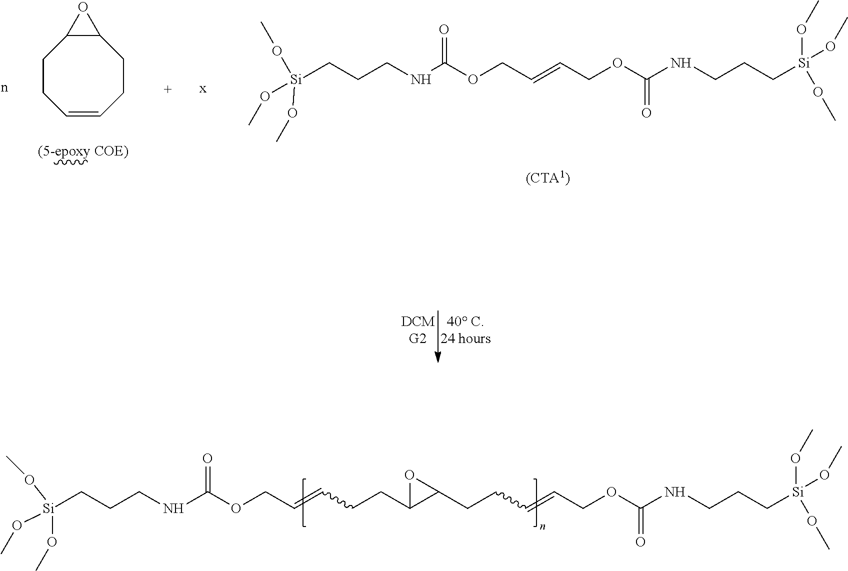

The polymer obtained was liquid at ambient temperature.

The NMR analyses of the polymer obtained for this test gave the following values, which have confirmed the structure of the polymer:

¹H NMR (CDCl₃, 500 MHz, 298 K): δ (ppm) repeat unit 1.29 (4H*n), 1.96 (4H*n), 2.72 (2H*n), 5.37 (2H*n), end group=0.64 (4H, m, —CH₂—CH₂—Si—), 1.61 (4H, m, —NH—CH₂—CH₂—CH₂—Si—), 3.16 (4H, m, —NH—CH₂—CH₂—CH₂—Si—), 3.57 (18H, s, —Si—O—CH₃), 4.48 (4H, t, —CO—O—CH₂—CH═), 5.73 (2H, m, —CH═CH—CH₂—O—CO—), 5.77 (2H, m, —CH═CH—CH₂—O—CO—).

¹³C NMR (CDCl₃, 100 MHz, 298 K): δ (ppm) repeat unit 29.17, 29.54, 29.78, 32.37, 33.10, 56.72, 130.48, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 65.57 (—CO—O—CH₂—CH═), 124.41 (CH═CH—CH₂—O—CO—), 136.05 (—CH═CH—CH₂—O—CO—), 156.50 (—O—CO—).

### Example 3: Synthesis of a Polymer Comprising Two Alkoxysilane End Groups Starting from 5-oxocyclooctene (5-O═COE) and CTA¹

The reaction was carried out according to the following scheme 5:

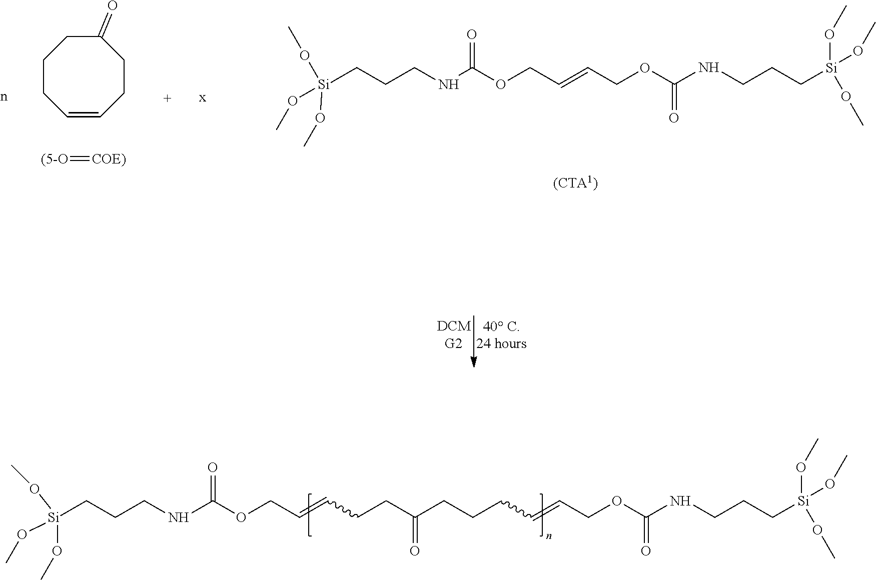

The polymer obtained was solid at ambient temperature.

The NMR analyses of the polymer obtained for this test gave the following values, which have confirmed the structure of the polymer:

¹H NMR (CDCl₃, 500 MHz, 298 K): δ (ppm) repeat unit 1.56 (2H*n), 1.91 (2H*n), 2.17-2.53 (6H*n), end group=0.64 (4H, m, —CH₂—CH₂—Si—), 1.61 (4H, m, —NH—CH₂—CH₂—CH₂—Si—), 3.16 (4H, m, —NH—CH₂—CH₂—CH₂—Si—), 3.57 (18H, s, —Si—O—CH₃), 4.48 (4H, t, —CO—O—CH₂—CH═), 5.73 (2H, m, —CH═CH—CH₂—O—CO—), 5.77 (2H, m, —CH═CH—CH₂—O—CO—).

¹³C NMR (CDCl₃, 100 MHz, 298 K): δ (ppm) repeat unit 21.51, 23.31, 26.53, 31.82, 42.17, 130.48, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 65.57 (—CO—O—CH₂—CH═), 124.41 (CH═CH—CH₂—O—CO—), 136.05 (—CH═CH—CH₂—O—CO—), 156.50 (—O—CO—).

### Example 4: Synthesis of a Polymer Comprising Two Alkoxysilane End Groups Starting from 5-hexylcyclooctene (5-Hexyl-COE) and CTA¹

The reaction was carried out according to the following scheme 6:

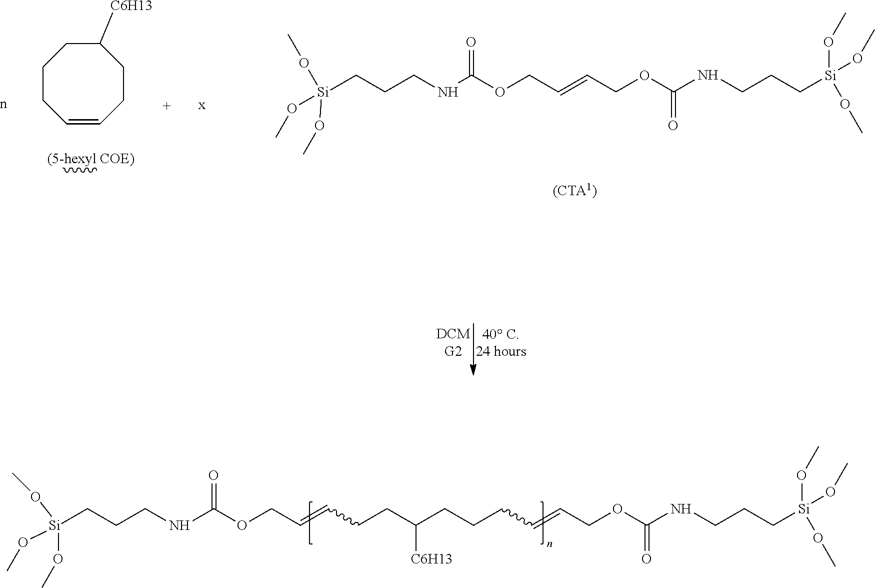

The polymer obtained was liquid at ambient temperature.

The NMR analyses of the polymer obtained for this test gave the following values, which have confirmed the structure of the polymer:

¹H NMR (CDCl₃, 500 MHz, 298 K): δ (ppm) repeat unit 0.83 (3H*n), 1.19 (2H*n), 1.27 (8H*n), 1.75 (2H*n), 1.96 (4H*n), 5.37 (2H*n), end group=0.64 (4H, m, —CH₂—CH₂—Si—), 1.61 (4H, m, —NH—CH₂—CH₂—CH₂—Si—), 3.16 (4H, m, —NH—CH₂—CH₂—CH₂—Si—), 3.57 (18H, s, —Si—O—CH₃), 4.48 (4H, t, —CO—O—CH₂—CH═), 5.73 (2H, m, —CH═CH—CH₂—O—CO—), 5.77 (2H, m, —CH═CH—CH₂—O—CO—).

¹³C NMR (CDCl₃, 100 MHz, 298 K): δ (ppm) repeat unit 14.1, 22.7, 27.4, 29.6, 31.8, 32.37, 33.10, 33.8, 40.65, 130.48, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 65.57 (—CO—O—CH₂—CH═), 124.41 (CH═CH—CH₂—O—CO—), 136.05 (—CH═CH—CH₂—O—CO—), 156.50 (—O—CO—).

### Example 5: Synthesis of a Polymer Comprising Two Alkoxysilane End Groups Starting from Cyclooctene (COE) and CTA²

The reaction was carried out according to the following scheme 7:

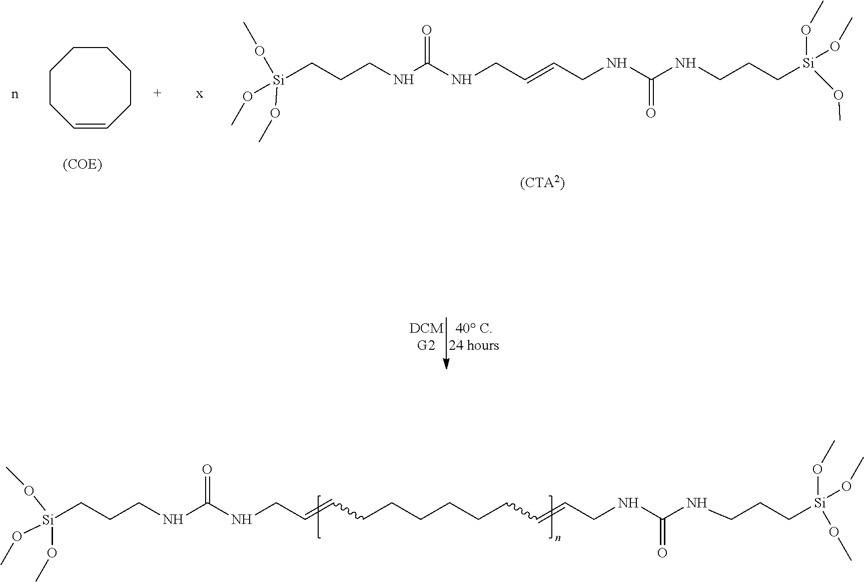

The polymer obtained was solid at ambient temperature.

The NMR analyses of the polymer obtained for this test gave the following values, which have confirmed the structure of the polymer:

¹H NMR (CDCl₃, 500 MHz, 298 K): δ (ppm) repeat unit 1.29 (8H*n), 1.96 (4H*n), 5.37 (2H*n), end group=0.64 (4H, m, —CH₂—CH₂—Si—), 1.61 (4H, m, —NH—CH₂—CH₂—CH₂—Si—), 3.21 (4H, m, —NH—CH₂—CH₂—CH₂—Si—), 3.57 (18H, s, —Si—O—CH₃), 3.83 (4H, t, —CO—NH—CH₂—CH═).

¹³C NMR (CDCl₃, 100 MHz, 298 K): δ (ppm) repeat unit 29.17, 29.54, 29.78, 32.37, 33.10, 130.48, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 52.57 (—CH═CH—CH₂—NH—CO—), 124.41 (—CH═CH—CH₂—NH—CO—), 136.05 (—CH═CH—CH₂—NH—CO—), 157.45 (—O—CO—).

### Example 6: Synthesis of a Polymer Comprising Two Alkoxysilane End Groups Starting from Cyclooctene (COE) and CTA³

The reaction was carried out according to the following scheme 8:

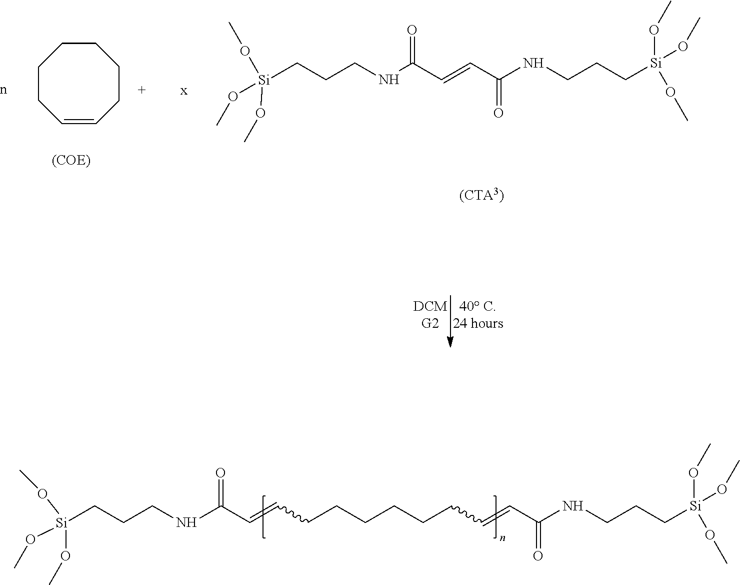

The polymer obtained was solid at ambient temperature.

The NMR analyses of the polymer obtained for this test gave the following values, which have confirmed the structure of the polymer:

¹H NMR (CDCl₃, 500 MHz, 298 K): δ (ppm) repeat unit 1.29 (8H*n), 1.96 (4H*n), 5.37 (2H*n), end group=0.64 (4H, m, —CH₂—CH₂—Si—), 1.61 (4H, m, —NH—CH₂—CH₂—CH₂—Si—), 3.18 (4H, m, —NH—CH₂—CH₂—CH₂—Si—), 3.57 (18H, s, —Si—O—CH₃), 6.26 (2H, m, —CH═CH— CO—), 6.62 (2H, m, —CH═CH—CO—).

¹³C NMR (CDCl₃, 100 MHz, 298 K): δ (ppm) repeat unit 29.17, 29.54, 29.78, 32.37, 33.10, 130.48, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 126.20 (CH═CH—CO—NH), 148.7 (—CH═CH—CO—NH), 167.18 (—CO—NH).

### Examples 7 and 8: Polymerization of a Mixture of Cycloolefins of Formulae (A) and (B)

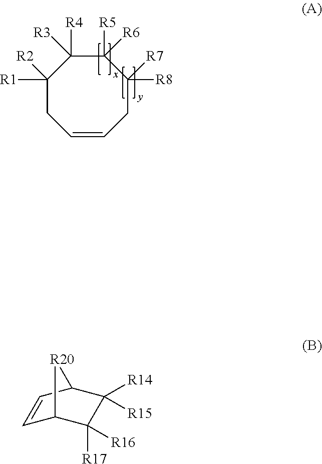

The polymerization process described below corresponds to examples 7 and 8, the results of which are shown in tables 4 and 5 below. The cycloolefins of formulae (A) and (B) used in examples 7 and 8 are respectively as follows:

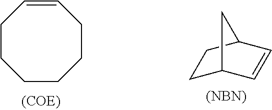

The cyclooctene (COE) with a purity of greater than 95% and the norbornene (NBN) with a purity of greater than 99% were commercial products from Sigma-Aldrich. They were distilled beforehand over CaH₂.

The starting materials, reactants and solvents used during these syntheses were commercial products from Sigma-Aldrich.

The cycloolefins of formulae (A) and (B), respectively COE (5.4 mmol) and NBN (5.4 mmol) described above, and dry CH₂Cl₂ (5 ml) were placed in a 100 ml round-bottomed flask in which was also placed a Teflon®-coated magnetic stirring bar. The round-bottomed flask and its contents were subsequently placed under argon. The compound of formula CTA¹ (for example 7) or CTA³ (for example 8) (0.54 mmol) was then introduced into the round-bottomed flask using a syringe. The round-bottomed flask was then immersed in an oil bath at 40° C. and then the catalyst G2 (5.4 μmol) in solution in CH₂Cl₂ (2 ml) was immediately added using a hollow needle. The reaction mixture then became very viscous in two minutes. The viscosity subsequently slowly decreased over the following 10 minutes. After 24 hours, counting from the addition of the catalyst, the product present in the round-bottomed flask was extracted after the solvent was concentrated under vacuum. A product was then recovered after precipitating from methanol, filtering and drying at 20° C. under vacuum (Yield 94% in this case). The ¹H/¹³C NMR analysis made it possible to demonstrate that the product was indeed a polymer having the expected formula.

All the polymers prepared in the examples were recovered as a solid powder or as a liquid, depending on the NBN/COE molar ratio, which is colorless, easily soluble in chloroform and insoluble in methanol.

The different tests of examples 7 and 8 are summarized in tables 4 and 5 and described in detail below.

TABLE 4

| Test | | Conversion | Mn_{SEC} | |
|---|---|---|---|---|
| No. | [A]/[B]/[CTA¹]/[Ru] (mol/mol) | (%) | (g/mol) | PDI |
| 7 | 1 000/1 000/100/1 | 100 | 4900 | 1.60 |

where CTA¹ = β-dicarbamate

TABLE 5

| Test | | Conversion | Mn_{SEC} | |
|---|---|---|---|---|
| No. | [A]/[B]/[CTA³]/[Ru] (mol/mol) | (%) | (g/mol) | PDI |
| 8 | 1 000/1 000/100/1 | 100 | 4800 | 1.58 |

where CTA³ = β-diamide

### Example 7: Synthesis of a Polymer Comprising Two Alkoxysilane End Groups Starting from Cyclooctene (COE), Norbornene (NBN) and CTA¹

The reaction was carried out according to the following scheme 9, in a molar ratio m:n equal to 0.3:1.0:

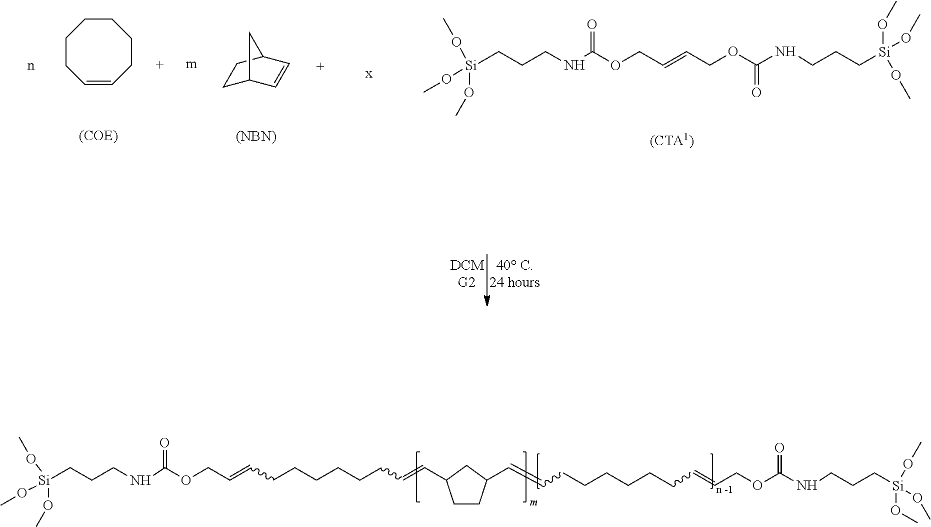

The polymer obtained was liquid at ambient temperature.

The NMR analyses of the polymer obtained for this test gave the following values, which have confirmed the structure of the polymer:

¹H NMR (CDCl₃, 500 MHz, 298 K): δ (ppm) repeat unit trans: 1.23 (12H*n), 1.72-1.89 (6H*n), 2.37 (2H*n trans), 5.31 (2H*n trans), cis: 1.23 (12H*n), 1.72-1.89 (6H*n), 2.72 (2H*n cis), 5.13 (2H*n cis), end group=0.64 (4H, m, —CH₂—CH₂—Si—), 1.61 (4H, m, —NH—CH₂—CH₂—CH₂—Si—), 3.16 (4H, m, —NH—CH₂—CH₂—CH₂—Si—), 3.57 (18H, s, —Si—O—CH₃), 4.48 (2H, t, —CO—O—CH₂—CH═), 5.73 (2H, m, —CH═CH—CH₂—O—CO—), 5.77 (2H, m, —CH═CH—CH₂—O—CO—).

¹³C NMR (CDCl₃, 100 MHz, 298 K): δ (ppm) repeat unit: 29.17, 29.54, 29.78, 32.37, 33.10, 38.02, 38.67, 41.35, 42.77, 43.13, 43.52, 130.35, 134.89, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 65.57 (—CO—O—CH₂—CH═), 124.41 (CH═CH—CH₂—O—CO—), 136.05 (—CH═CH—CH₂—O—CO—), 156.50 (—O—CO—).

### Example 8: Synthesis of a Polymer Comprising Two Alkoxysilane End Groups Starting from Cyclooctene (COE), Norbornene (NBN) and CTA³

The reaction was carried out according to the following scheme 10, in a molar ratio m:n equal to 0.3:1.0:

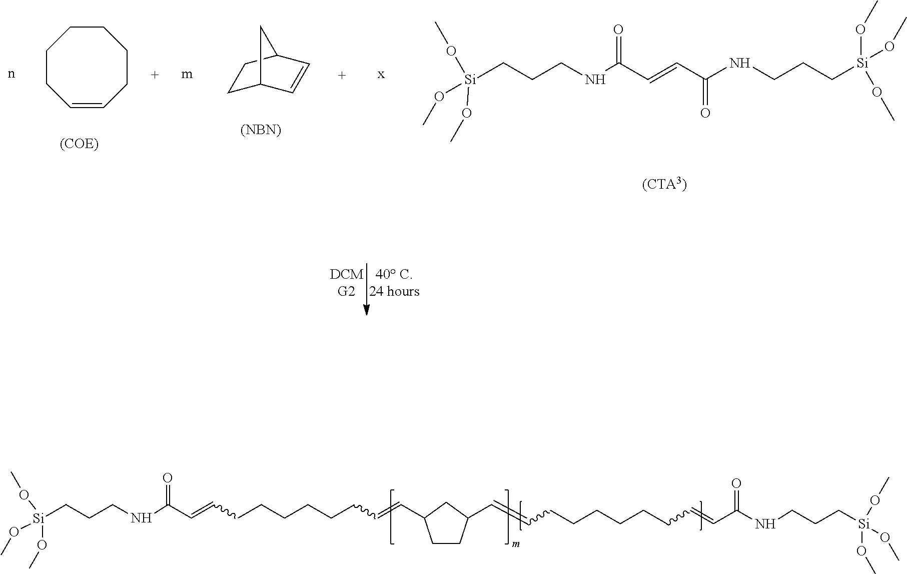

The polymer obtained was liquid at ambient temperature.

The NMR analyses of the polymer obtained for this test gave the following values, which have confirmed the structure of the polymer:

¹H NMR (CDCl₃, 500 MHz, 298 K): δ (ppm) repeat unit trans: 1.23 (12H*n), 1.72-1.89 (6H*n), 2.37 (2H*n trans), 5.31 (2H*n trans), cis: 1.23 (12H*n), 1.72-1.89 (6H*n), 2.72 (2H*n cis), 5.13 (2H*n cis), end group=0.64 (4H, m, —CH₂—CH₂—Si—), 1.61 (4H, m, —NH—CH₂—CH₂—CH₂—Si—), 3.18 (4H, m, —NH—CH₂—CH₂—CH₂—Si—), 3.57 (18H, s, —Si—O—CH₃), 6.26 (2H, m, —CH═CH— CO—), 6.62 (2H, m, —CH═CH—CO—).

¹³C NMR (CDCl₃, 100 MHz, 298 K): δ (ppm) repeat unit: 29.17, 29.54, 29.78, 32.37, 33.10, 38.02, 38.67, 41.35, 42.77, 43.13, 43.52, 130.35, 134.89, end group=6.28 (—CH₂—CH₂—Si—), 23.17 (—NH—CH₂—CH₂—CH₂—Si—), 43.34 (—NH—CH₂—CH₂—CH₂—Si—), 50.77 (—Si—O—CH₃), 126.20 (CH═CH—CO—NH), 148.7 (—CH═CH— CO—NH), 167.18 (—CO—NH).

### Example 9: Preparation of an Adhesive Composition from a Polymer Comprising Two Alkoxysilane End Groups

8 adhesive compositions, each comprising 0.2% by weight of a crosslinking catalyst consisting of dioctyltin dineodecanoate (product Tib kat 223 from Tib Chemicals) and a polymer according to the invention obtained in examples 1 to 8, were prepared by simple mixing.

Each mixture thus obtained was left under reduced stirring (20 mbar, i.e. 2000 Pa) for 15 minutes, before the composition thus obtained is packaged in an aluminum cartridge.

The measurement of the breaking strength and of the elongation at break by a tensile test was carried out, for each of the 8 adhesive compositions, according to the protocol described below.

The principle of the measurement consists in drawing, in a tensile testing device, the moving jaw of which moves at a constant rate equal to 100 mm/min, a standard test specimen consisting of the crosslinked adhesive composition and in recording, at the moment when breaking of the test specimen occurs, the tensile stress applied (in MPa) and also the elongation of the test specimen (in %).

The standard test specimen has the shape of a dumbbell, as illustrated in the international standard ISO 37. The narrow part of the dumbbell used has a length of 20 mm, a width of 4 mm and a thickness of 500 μm.

In order to prepare the dumbbell, the composition, packaged as described above, was heated to 100° C. and then the amount necessary to form, on an A4 sheet of silicone-treated paper, a film having a thickness of 300 μm is extruded over this sheet, which film was left at 23° C. and 50% relative humidity for 7 days for crosslinking. The dumbbell is then obtained by simple cutting out from the crosslinked film.

The dumbbell of each of the 8 adhesive compositions tested then exhibits an ultimate strength of greater than 0.7 MPa with an elongation at break of greater than 200%.

Each adhesive composition was subsequently subjected to tests of adhesive bonding of two strips of wood (each with a size of 20 mm×20 mm×2 mm) in order to result, after crosslinking at 23° C. for seven days, in a breaking force of greater than 2 MPa in adhesive failure.

1-15. (canceled)

16. A hydrocarbon polymer comprising two alkoxysilane end groups, said hydrocarbon polymer being of following formula (1): 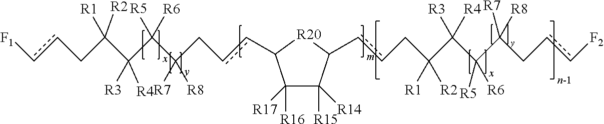
wherein:
F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}; or
F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}; or
F₁ is (R′O)_{3-z}R_{z}Si—R″—NH—CO—(CH₂)ₚ₂— and F₂ is —(CH₂)_{q2}—CONH—R″—SiR_{z}(OR′)_{3-z};
wherein z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group; the R″ group is an alkylene group comprising from 1 to 4 carbon atoms; and wherein:
each carbon-carbon bond of the chain denoted [symbol] is a double bond or a single bond, in accordance with the valency rules of organic chemistry;
the R1, R2, R3, R4, R5, R6, R7 and R8 groups are independently a hydrogen, a halogen atom, an alkyl group, a heteroalkyl group, an alkoxycarbonyl group or a heteroalkoxycarbonyl group, it being possible for at least one of the R1 to R8 groups to form part of one and the same saturated or unsaturated ring or heterocycle with at least one other of the R1 to R8 groups, according to the valency rules of organic chemistry, and it being possible for at least one of the (R1,R2), (R3,R4), (R5,R6) and (R7,R8) pairs to be an oxo group;
x and y are integers independently within a range extending from 0 to 5;
the R14, R15, R16 and R17 groups are independently a hydrogen, a halogen atom, an alkyl group, an alkenyl group, a heteroalkyl group, an alkoxycarbonyl group or a heteroalkoxycarbonyl group, it being possible for at least one of the R14 to R17 groups to form part of one and the same saturated or unsaturated ring or heterocycle with at least one other of the R14 to R17 groups, according to the valency rules of organic chemistry;
the R20 group is CH₂, O, S, NR₀ or C(═O), R₀ being an alkyl or alkenyl group comprising from 1 to 22 carbon atoms; and
n is an integer greater than or equal to 2 and m is an integer greater than or equal to 0, the molar ratio m:n being within a range from 0:1 to 0.5:1, n and m in addition being such that the number-average molar mass Mn of the hydrocarbon polymer of formula (1) is within a range from 400 to 50,000 g/mol, and the polydispersity (PDI) of the hydrocarbon polymer of formula (1) is within a range from 1.0 to 3.0.

17. The hydrocarbon polymer of claim 16, wherein x=y=1.

18. The hydrocarbon polymer of claim 16, wherein m is equal to 0, whereby the polymer is of the following formula (2):

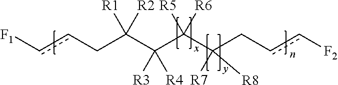

19. The hydrocarbon polymer of claim 16, wherein the polymer has the formula (1′):

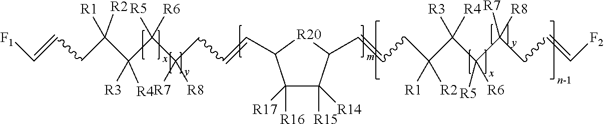

20. The hydrocarbon polymer of claim 16, wherein F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}, with p1=1 or q1=1.

21. The hydrocarbon polymer of claim 20, wherein R′ is a methyl, R″ is a —CH₂— or —(CH₂)₃— group, z=0, p1=1 and q1=1.

22. The hydrocarbon polymer of claim 16, wherein F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}, with p1=1 or q1=1.

23. The hydrocarbon polymer of claim 22, wherein R′ is a methyl, R″ is a —CH₂— or —(CH₂)₃— group, z=0, p1=1 and q1=1.

24. The hydrocarbon polymer of claim 16, wherein F₁ is (R′O)_{3-z}R_{z}Si—R″—NH—CO—(CH₂)ₚ₂— and F₂ is —(CH₂)_{q2}—CONH—R″—SiR_{z}(OR′)_{3-z}, with p2=0 or q2=0.

25. The hydrocarbon polymer of claim 24, wherein R′ is a methyl, R″ is a —CH₂— or —(CH₂)₃— group, z=0, p2=0 and q2=0.

26. A process for the preparation of the hydrocarbon polymer of claim 16, said process comprising at least one stage of ring-opening metathesis polymerization, in the presence of:
at least one metathesis catalyst,
at least one difunctional alkoxysilane chain transfer agent (CTA) of the following formula (C): 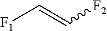
in which the [symbol] bond is a bond geometrically oriented on one side or the other, with respect to the double bond (cis or trans); F₁ is (R′O)_{3-z}R_{z}Si—R″—NH—COO—(CH₂)ₚ₁— and F₂ is —(CH₂)_{q1}—OOC—NH—R″—SiR_{z}(OR′)_{3-z}; or F₁ is (R′O)_{3-z}R_{z}Si—R″—NH—CO—NH—(CH₂)ₚ₁— and F₂ is —(CH₂)_{q1}—NH—CO—NH—R″—SiR_{z}(OR′)_{3-z}; or F₁ is (R′O)_{3-z}R_{z}Si—R″—NH—CO—(CH₂)ₚ₂— and F₂ is —(CH₂)_{q2}—CO—NH—R″—SiR_{z}(OR′)_{3-z}; wherein z is an integer equal to 0, 1, 2 or 3; p1 and q1 are independently an integer equal to 1, 2 or 3; p2 and q2 are independently an integer equal to 0, 1, 2 or 3; the R and R′ groups are independently an alkyl group; the R″ group is an alkylene group;
at least one compound of the following formula (A): 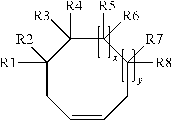
wherein:
the R1, R2, R3, R4, R5, R6, R7 and R8 groups are independently a hydrogen, a halogen atom, an alkyl group, a heteroalkyl group, an alkoxycarbonyl group or a heteroalkoxycarbonyl group, it being possible for at least one of the R1 to R8 groups to form part of one and the same saturated or unsaturated ring or heterocycle with at least one other of the R1 to R8 groups, according to the valency rules of organic chemistry, and it being possible for at least one of the (R1,R2), (R3,R4), (R5,R6) and (R7,R8) pairs to be an oxo group;
x and y are integers independently within a range extending from 0 to 5;
and
optionally at least one compound of formula (B): 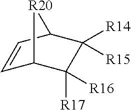
wherein:
the R14, R15, R16 and R17 groups are independently a hydrogen, a halogen atom, an alkyl group, an alkenyl group, a heteroalkyl group, an alkoxycarbonyl group or a heteroalkoxycarbonyl group, it being possible for at least one of the R14 to R17 groups to form part of one and the same saturated or unsaturated ring or heterocycle with at least one other of the R14 to R17 groups, according to the valency rules of organic chemistry; and
the R20 group is CH₂, O, S, NR₀ or C(═O), R₀ being an alkyl group;
for a reaction time ranging from 2 to 24 hours and at a temperature within a range from 20 to 60° C.

27. The process of claim 26, wherein the molar ratio of the CTA to the compound of formula (A), or to the sum of the compounds of formulae (A) and (B) if the compound of formula (B) is present, is within a range from 0.01 to 0.10.

28. The process of claim 26, wherein the CTA is selected from the group consisting of:

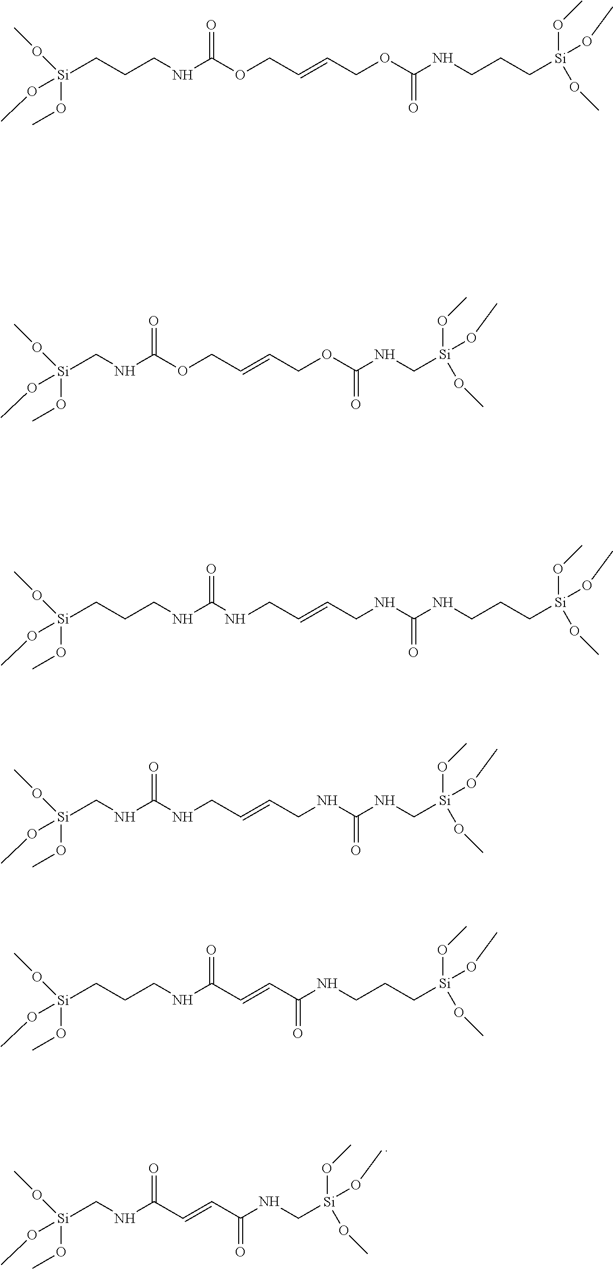

29. An adhesive composition comprising the polymer of claim 16 and from 0.01 to 3% by weight of at least one crosslinking catalyst, with respect to the weight of the adhesive composition.

30. A process for adhesive bonding by assembling two substrates, comprising:
coating the adhesive composition of claim 29, in the liquid form, onto a surface of at least one of the two substrates; and
bringing the two substrates into contact along their faying surfaces.
